(19) United States
(12) Patent Application Publication
(10) Pub. No.: US 2020/0323356 A1
(43) Pub. Date: Oct. 15, 2020

(54) MATTRESS INTERIOR, MATTRESS AND METHOD OF MANUFACUTURING A MATTRESS

(71) Applicant: ZOMMOS HOLDINGS LIMITED, Stoke-on-Trent Staffordshire (GB)

(72) Inventor: Andrew HAWLEY, Stoke-on-Trent, Staffordshire (GB)

(73) Assignee: DREAMRIGHT BEDS LIMITED, Stoke-on-Trent, Staffordshire (GB)

(21) Appl. No.: 16/760,789

(22) PCT Filed: Nov. 1, 2018
(86) PCT No.: PCT/EP2018/079959

§ 371 Date: Apr. 30, 2020

(30) Foreign Application Priority Data
Mar. 11, 2017 (GB) 1718219.7

(51) Int. Cl. A47C 27/08; A47C 27/10; B68G 7/06; A47C 27/18

(52) U.S. Cl. CPC A47C 27/088; A47C 27/081; A47C 27/18; B68G 7/06; A47C 27/10

(57) ABSTRACT

A mattress interior is provided that includes an outer framework made of a self-supporting, resilient material, and an air compartment made of a flexible, substantially airtight material, having an internal cavity which can be inflated and deflated. The air compartment is secured within the outer framework by being connected to the outer framework, and/or elements of the outer framework being connected to each other. An air mattress is also provided that includes the mattress interior, and a cover. A method of manufacturing a mattress is additionally provided that includes constructing the outer framework, inflating one or more air compartments, assembling the mattress by securing the air compartments within the outer framework to make a mattress interior and fitting the mattress interior with a cover, deflating the one or more air compartments, and packing the mattress into a smaller volume.

The present invention concerns a mattress interior, a mattress and a method of manufacturing a mattress.

Mattresses are well known as components of beds. Generally speaking, a traditional mattress comprises a mattress interior fitted with an outer cover. The mattress interior may, for example, comprise a plurality of springs or other resilient members for giving support to someone lying on the mattress. It is well known that such traditional mattresses can be bulky, heavy, and difficult to move or transport.

More recently, it is has become known for some mattresses to comprise a mattress interior fitted with an outer cover, wherein the mattress interior comprises an outer framework made of a self-supporting, resilient material, such as polyurethane foam, and one or more air compartments. The one or more air compartments each has an internal cavity, which can be inflated with air and also deflated via a tube, which is in communication with the internal cavity. Such mattresses, which will be referred to hereinafter as air mattresses, are convenient for providing adjustable levels of support to someone lying on the mattress, according to the level of inflation or deflation of the one or more air compartments. An example of such a mattress is the Sleep Number ILE™ available from Select Comfort Corporation of Minnesota, United States of America.

Since the one or more air compartments of an air mattress can be completely deflated, mattresses of this type can be dispatched from a factory where they are made, as a kit of component parts for assembly by an end user. Although the component parts of such a kit are individually less bulky and heavy than a traditional mattress, and are therefore also easier to move and transport, such an approach also has its own disadvantages. Firstly, the assembly of the component parts into a finished air mattress can take the end user about an hour to perform. Secondly, the end user generally also has no prior experience of assembling such a kit of parts into a finished air mattress, so must therefore usually follow a set of assembly instructions, which are open to misinterpretation by the end user and which can therefore lead to errors in assembly, and frustration on the part of the end user.

Accordingly, it would be desirable to provide an alternative approach, which allows a mattress to be moved and transported more quickly and easily than a traditional mattress, but which also does not require any assembly on the part of an end user of the mattress.

An object of the present invention is therefore to address these problems in the prior art. A further object of the present invention is to provide a mattress interior, a mattress and a method of manufacturing a mattress.

Accordingly, in a first aspect, the present invention provides a mattress interior comprising an outer framework made of a self-supporting, resilient material, and one or more air compartments, each made of a flexible, substantially airtight material, wherein the one or more air compartments can be inflated and deflated. The one or more air compartments are secured within the outer framework by at least one of (a) being connected to the outer framework, and (b) elements of the outer framework being connected to each other to contain the one or more air compartments therein.

Such a mattress interior therefore differs from the mattress interior of a known type of air mattress in that the one or more air compartments are secured within the outer framework by at least one of (a) being connected to the outer framework, and (b) elements of the outer framework being connected to each other. This has the advantage that the mattress interior can be fitted with a cover to make a finished air mattress, which can then be packed for dispatch from the factory where the mattress has been made. Upon receipt of the mattress by an end user, the end user need only unpack the mattress and inflate the one or more air compartments as desired; there is no assembly required on the part of the end user.

In one possible embodiment, each of the one or more air compartments may be generally cuboidal in shape, with a pair of end faces, a pair of side faces, and two opposing major surfaces respectively defining top and bottom faces of the air compartment, and each of the one or more air compartments may comprises a flange extending around an edge of each of the top and bottom faces. This is advantageous because the flanges can be constructed by extending a seam joining a respective one of the end or side faces on the one hand with one of the top and bottom faces on the other, and the flanges can be connected to the outer framework of the mattress interior to secure the one or more air compartments within the outer framework.

A width of each flange preferably lies in a range of from about 40 mm to about 150 mm, more preferably from about 45 mm to about 120 mm, and most preferably from about 80 mm to about 100 mm.

The outer framework may comprise two end walls and two side walls each of which is generally cuboidal in shape, and all of which are of a similar height to each other, which height is substantially equal to a separation between the flanges around the edges of each of the top and bottom faces of the one or more air compartments, the end and side walls being connected to the flanges. This has the advantage of forming the mattress interior into an integrated whole, which can be readily fitted with a cover to make a finished air mattress, which can then be packed for dispatch from the factory where the mattress has been made.

In such a case, the mattress interior may comprises two such air compartments and the outer framework may further comprise a central wall which is generally cuboidal in shape and of a similar height to the end and side walls, the central wall extending between the middles of each of the two end walls, dividing a space between the side walls into two substantially equal halves, each of which contains one of the two air compartments, the central wall being connected to the flanges of the two air compartments. This has the advantage of making the mattress interior suitable for a mattress for a double bed.

In such a case, a width of the flanges of the two air compartments adjacent to the central wall is preferably less than the width of the flanges adjacent to the end and side walls, and the flanges of one of the two air compartments adjacent to the central wall are in edgewise abutment with the flanges of the other of the two air compartments adjacent to the central wall. This has the advantage of avoiding an overlap of the flanges of the two air compartments, which might otherwise create an undesirable ridge down the centre of such a double mattress.

In such a case, however, the mattress interior preferably further comprises a strip of material, positioned over a join between the flanges of the two air compartments and the central wall and connected to the flange of each air compartment. This strip of material has the advantage of improving the security of the connection between the flanges of the two air compartments and the central wall, in spite of the reduced width of the flanges at this junction.

In an alternative possible embodiment, the outer framework may comprise two end walls and two side walls, each of which is generally cuboidal in shape, and all of which are of a similar height to each other, a bottom layer, and a top layer, wherein the end walls and the side walls are positioned on and connected to the bottom layer, and the top layer is positioned on and connected to the end walls and the side walls. This has the advantage of creating a generally cuboidal box in which the one or more air compartments are contained, thereby forming the mattress interior into an integrated whole, which can be readily fitted with a cover to make a finished air mattress, which can then be packed for dispatch from the factory where the mattress has been made.

Preferably, the top layer is substantially thicker than the bottom layer. This has the advantage that whereas the top and bottom layers both give structural integrity to the outer framework, the increased thickness of the top layer also gives additional comfort to the end user during use of the finished air mattress.

If the outer framework does form a generally cuboidal box in which the one or more air compartments are contained, the mattress interior may comprise two such air compartments and the outer framework may further comprise a central wall which is generally cuboidal in shape and of a similar height to the end and side walls, the central wall extending between the middles of each of the two end walls, dividing a space between the side walls into two substantially equal halves, each of which contains one of the two air compartments, the central wall being connected to the bottom layer and the top layer. This has the advantage of making the mattress interior suitable for a mattress for a double bed.

In any case, at least one of the one or more air compartments may comprise a plurality of internal cavities, each of which can be inflated and deflated independently of each other. This has the advantage of allowing the mattress interior to provide separately adjustable levels of support for different parts of a prone human body, such as the head and shoulders, the torso and arms, and the legs.

Preferably, the self-supporting, resilient material is polyurethane foam.

Preferably, the flexible, substantially airtight material is rubberized cotton.

In a second aspect, the present invention provides a mattress comprising a mattress interior as described herein and a cover fitted to an outside of the mattress interior.

In a third aspect, the present invention also provides a method of manufacturing a mattress, the method comprising constructing an outer framework made of a self-supporting, resilient material, inflating one or more air compartments each made of a flexible, substantially airtight material, assembling the mattress by securing the one or more air compartments within the outer framework to make a mattress interior and fitting the mattress interior with a cover, deflating the one or more air compartments, and packing the mattress into a smaller volume.

This method is advantageous because the one or more inflated air compartments provide a three-dimensional shape around which the mattress can be assembled, but following assembly of the mattress, deflating the one or more air compartments allows the finished mattress to be packed into a smaller volume for convenient dispatch from the factory where the mattress has been made. Thus an end user of the mattress only needs to unpack the finished mattress and inflate the one or more air compartments as desired, and there is no assembly required on the part of the end user.

Preferably, the one or more air compartments are secured within the outer framework by connecting the one or more air compartments to the outer framework.

Alternatively or additionally, the one or more air compartments may be secured within the outer framework by connecting elements of the outer framework to each other to contain the one or more air compartments therein.

In either case, this has the advantage of forming the mattress interior into an integrated whole, which can be safely packed into a smaller volume without disrupting the mattress's internal structure.

Preferably, the mattress is packed into a smaller volume using a roll-packing machine. This has the advantage of preserving the internal structure of the mattress in the best possible manner and allows the end user to just unroll the mattress and inflate it ready for use.

Further features and advantages of the present invention will become apparent from the following detailed description, which is given by way of example and in association with the accompanying drawings, in which:

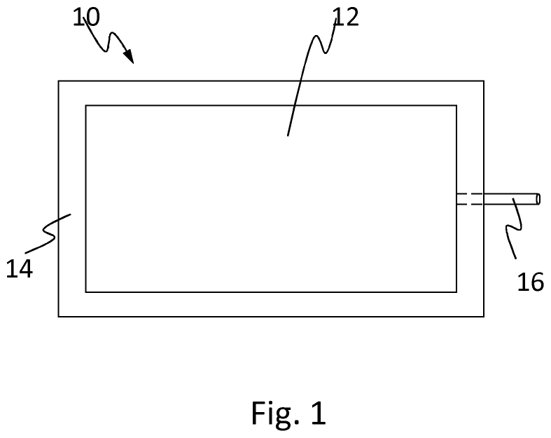

FIG. 1 is a schematic top plan view of a first type of air compartment;

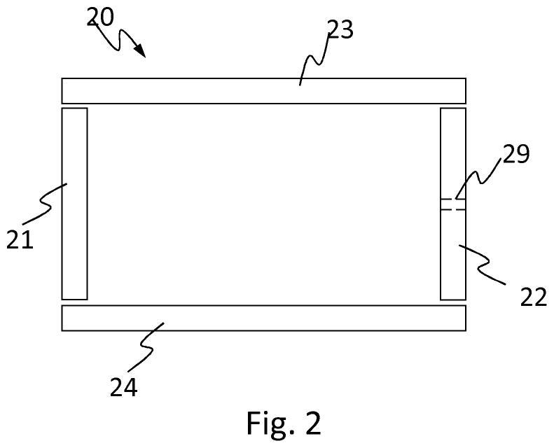

FIG. 2 is a schematic top plan view of a first type of outer framework;

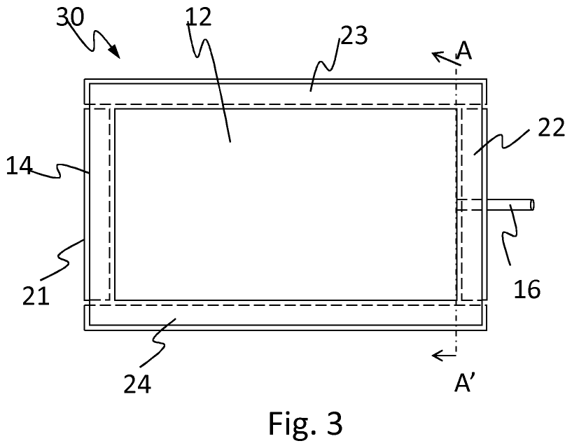

FIG. 3 is a schematic top plan view of a first embodiment of a mattress interior, which is suitable for a single bed and comprises an air compartment of the type shown in FIG. 1 and an outer framework of the type shown in FIG. 2;

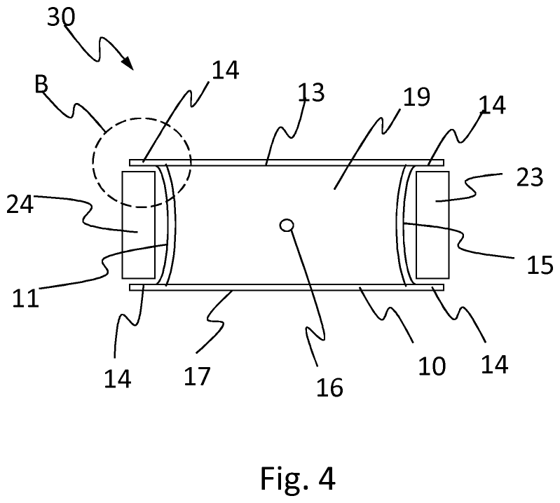

FIG. 4 is a schematic cross-sectional view of the mattress interior of FIG. 3 taken along the line A-A′ shown in FIG. 3 and looking in the direction indicated by the arrows at each end of the line A-A′;

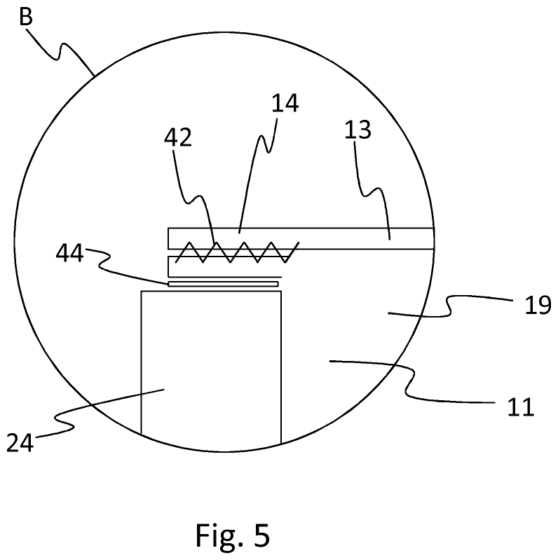

FIG. 5 is an enlarged schematic view of the area of FIG. 4 indicated by the circle labelled B in FIG. 4;

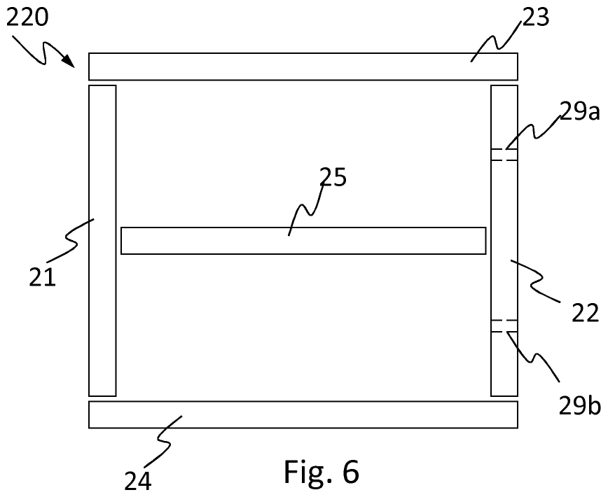

FIG. 6 is a schematic top plan view of a second type of outer framework;

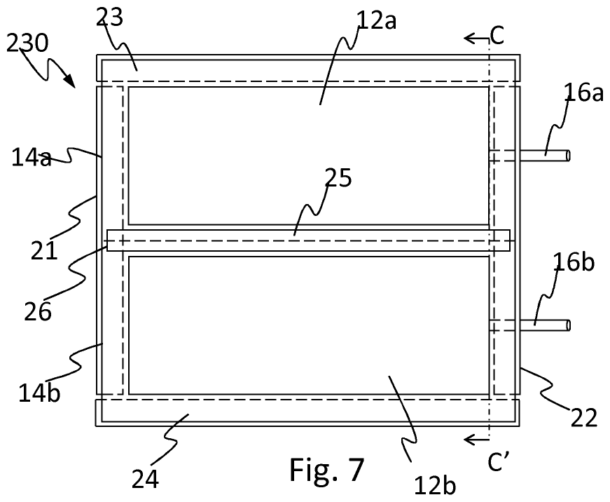

FIG. 7 is a schematic top plan view of a second embodiment of a mattress interior, which is suitable for a double bed and comprises two air compartments of the type shown in FIG. 1 and an outer framework of the type shown in FIG. 6;

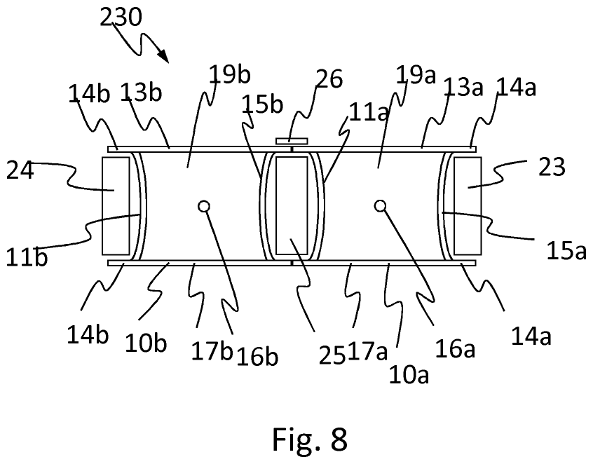

FIG. 8 is a schematic cross-sectional view of the mattress interior of FIG. 7 taken along the line C-C′ shown in FIG. 7 and looking in the direction indicated by the arrows at each end of the line C-C′;

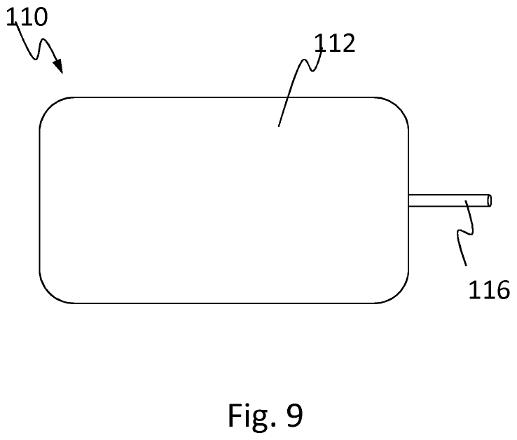

FIG. 9 is a schematic top plan view of a second type of air compartment;

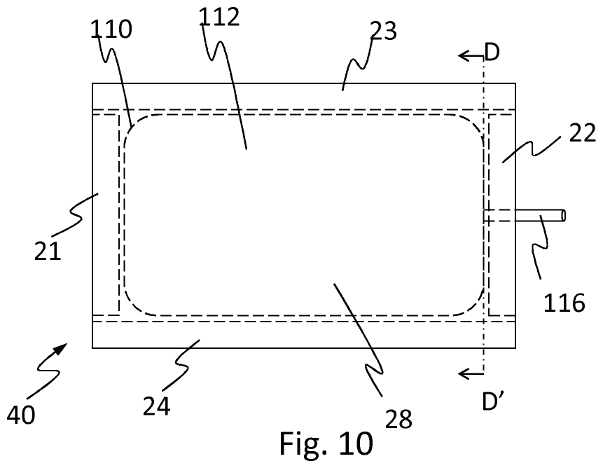

FIG. 10 is a schematic top plan view of a third embodiment of a mattress interior, which is suitable for a single bed and comprises an air compartment of the type shown in FIG. 9 and an outer framework of the type shown in FIG. 2;

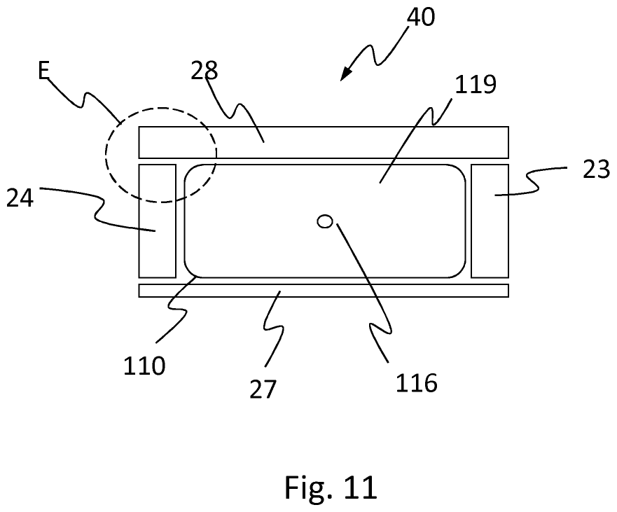

FIG. 11 is a schematic cross-sectional view of the mattress interior of FIG. 10 taken along the line D-D′ shown in FIG. 10 and looking in the direction indicated by the arrows at each end of the line D-D′;

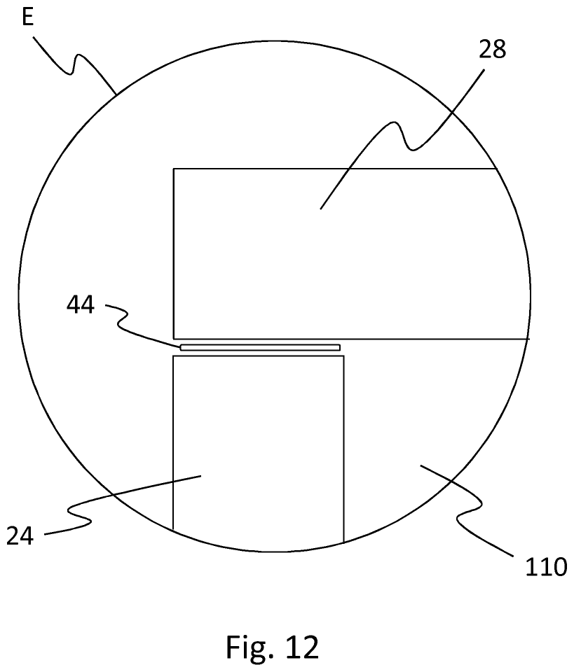

FIG. 12 is an enlarged schematic view of the area of FIG. 11 indicated by the circle labelled E in FIG. 11;

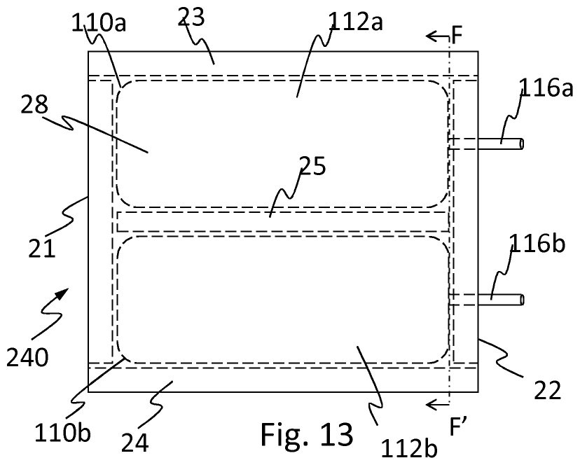

FIG. 13 is a schematic top plan view of a fourth embodiment of a mattress interior, which is suitable for a double bed and comprises two air compartments of the type shown in FIG. 9 and an outer framework of the type shown in FIG. 6;

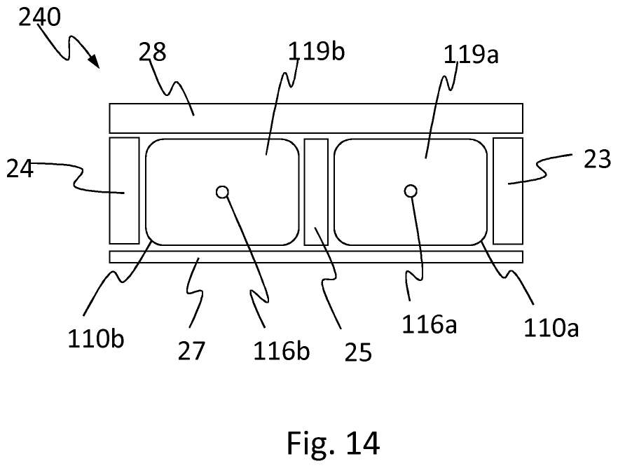

FIG. 14 is a schematic cross-sectional view of the mattress interior of FIG. 13 taken along the line F-F′ shown in FIG. 13 and looking in the direction indicated by the arrows at each end of the line F-F′; and

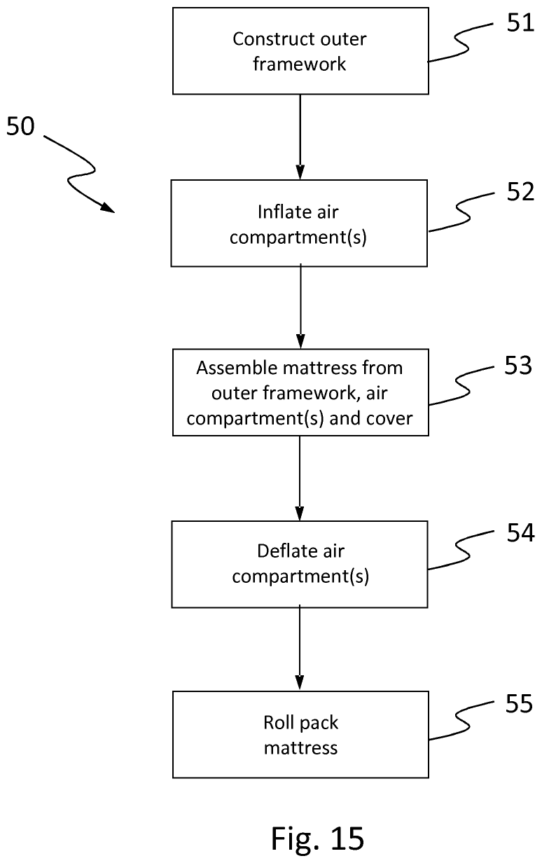

FIG. 15 schematically represents an embodiment of a method of manufacturing a mattress.

Referring firstly to FIG. 1, there is shown a first type of air compartment 10. The air compartment 10 is generally cuboidal in shape, with a pair of end faces 19, a pair of side faces 11, 15, and two opposing major surfaces, the last of which respectively define top and bottom faces 13, 17 of the air compartment 10. The air compartment 10 is made of a flexible but substantially airtight material, such as rubberized cotton. Extending around an edge of each of the opposing major surfaces of the air compartment 10 is a flange 14, which is also made of the flexible but substantially airtight material. The flanges 14 can be constructed by extending a seam joining a respective one of the end faces 19 or the side faces 11, 15 on the one hand with one of the top and bottom faces 13, 17 of the air compartment 10 on the other. The flanges 14 can typically each have a width of about 90 mm.

The air compartment 10 also comprises an internal cavity 12, which can be inflated with air and also deflated via a tube 16, which is in communication with the internal cavity 12. The tube 16 may further comprise a substantially airtight valve. Whereas in the representative example shown in FIG. 1, the tube 16 is mounted on one of the two end faces 19 of the air compartment 10, it could equally well instead be on one of the two side faces 11, 15.

FIG. 2 shows a first type of outer framework 20. The outer framework 20 comprises two end walls 21, 22 and two side walls 23, 24, each of which is generally cuboidal in shape. The end and side walls 21, 22, 23, 24 are all made of a self-supporting but resilient and relatively soft material, such as polyurethane foam. The end wall 22 comprises a through-hole or channel 29, through which the tube 16 of the air compartment 10 shown in FIG. 1 can be fed. All of the end and side walls 21, 22, 23, 24 are of a similar height to each other, which is substantially equal to a separation between the flanges 14 around the edges of each of the top and bottom faces 13, 17 of the air compartment 10.

FIGS. 3 and 4 show a first embodiment of a mattress interior 30, which is suitable for a single bed. A mattress may be made by fitting the mattress interior 30 with a cover, for example made of fabric. The cover may be permanently fixed to the mattress interior 30, for example by stitching, or the cover may be removable, for example if it comprises one or more fasteners, such as zips.

The mattress interior 30 comprises an air compartment 10 of the type shown in FIG. 1 and an outer framework 20 of the type shown in FIG. 2. The mattress interior 30 is assembled by placing the air compartment 10 in the outer framework 20, feeding the tube 16 of the air compartment 10 through the through-hole or channel 29 formed in the end wall 22, inflating the air compartment 10 via the tube 16, and uniting the air compartment 10 with the outer framework 20 by connecting the end and side walls 21, 22, 23, 24 of the outer framework 20 to each of the flanges 14 of the air compartment 10 in a manner which can be best understood by reference to FIG. 5.

FIG. 5 shows an enlargement of the area of FIG. 4 indicated by the circle labelled B in FIG. 4. As may be seen from FIG. 5, the flange 14 is formed by joining the side face 11 and the top face 13 of the air compartment 10 together, for example by means of stitching 42. In this embodiment, flange 14 is connected to side wall 24 by bonding flange 14 and side wall 24 together using a layer of adhesive 44. Alternatively or additionally, flange 14 can be connected to side wall 24 by stapling flange 14 and side wall 24 together.

FIG. 6 shows a second type of outer framework 220. Like the first type of outer framework 20 shown in FIG. 2, this second type of outer framework 220 also comprises two end walls 21, 22 and two side walls 23, 24, each of which is generally cuboidal in shape. However, the second type of outer framework 220 further comprises a central wall 25, which is also generally cuboidal in shape and which extends between the middles of each of the two end walls 21, 22, dividing the space between the side walls 23, 24 into two substantially equal halves. The end wall 22 comprises two through-holes or channels 29a, 29b, each of which gives access to one of these two halves and through each of which the tube 16 of an air compartment 10 of the type shown in FIG. 1 can be fed. The end, side and central walls 21, 22, 23, 24, 25 of this second type of outer framework 220 are also all made of a self-supporting but resilient and relatively soft material, such as polyurethane foam. The walls 21, 22, 23, 24, 25 are again also all of a similar height to each other, which is substantially equal to a separation between the flanges 14 around the edges of each of the top and bottom faces 13, 17 of an air compartment of the type shown in FIG. 1.

FIGS. 7 and 8 show a second embodiment of a mattress interior 230, which is suitable for a double bed. As before, a mattress may be made from the mattress interior 230 by fitting it with a cover, for example made of fabric, which may be permanently fixed to the mattress interior 230, for example by stitching, or which may be removable, for example if the cover comprises one or more fasteners, such as zips.

The mattress interior 230 comprises an outer framework 220 of the type shown in FIG. 6 and two air compartments 10a, 10b of the type shown in FIG. 1, each of which is contained in one of the two substantially equal halves of the space between the side walls 23, 24. As before, the two air compartments 10a, 10b are each generally cuboidal in shape, each having a pair of end faces 19a, 19b, a pair of side faces 11a 15a; 11b, 15b, and two opposing major surfaces, which respectively define top and bottom faces 13a, 17a; 13b, 17b of each one of the air compartments 10a, 10b. As before, the two air compartments 10a, 10b each also have respective flanges 14a, 14b, which extend around an edge of each of the opposing major surfaces of each air compartment 10a, 10b and are made of the same flexible but substantially airtight material. In the present case, however, the width of the flanges 14a, 14b along the edges of the top and bottom faces 13a, 17a; 13b, 17b adjacent to one of the side faces 11a, 15b of each of the two air compartments 10a, 10b is less than the width of the flanges 14a, 14b along the other three edges of the top and bottom faces 13a, 17a; 13b, 17b. The width of the flanges 14a, 14b adjacent to the central wall 25 is therefore typically only equal to about 45 mm, rather than 90 mm, and is therefore substantially less than the width of the flanges 14a, 14b adjacent to the end and side walls 21, 22, 23, 24.

Each of the two air compartments 10a, 10b comprises a respective internal cavity 12a, 12b, which can be inflated with air and also deflated via a respective tube 16a, 16b, which is in communication with the internal cavity 12a 12b. One or both of the tubes 16a, 16b may further comprise a substantially airtight valve. Whereas in the representative example shown in FIGS. 7 and 8, the tubes 16a, 16b are each mounted on an end face 19a, 19b of the air compartments 10a, 10b, they could equally well instead be on one of the side faces 15a, 11b.

The mattress interior 230 shown in FIGS. 7 and 8 is assembled by placing each of the two air compartments 10a, 10b in a respective one of the two halves of the outer framework 220, one on each side of the central wall 25. The respective tubes 16a, 16b of the two air compartments 10a, 10b are then fed through a respective one of the two through-holes or channels 29a, 29b formed in the end wall 22, before the two air compartments 10a, 10b are inflated. The two air compartments 10a, 10b are then united with the outer framework 220 by connecting the end, side and central walls 21, 22, 23, 24, 25 of the outer framework 220 to whichever one or ones of the respective flanges 14a, 14b of the two air compartments 10a, 10b they are adjacent, by connecting them together in a similar manner to that described above with reference to FIG. 5. Alternatively or additionally, the respective flanges 14a, 14b of the two air compartments can be connected to the end, side and central walls 21, 22, 23, 24, 25 to which they are adjacent by stapling respective ones of the walls 21, 22, 23, 24, 25 and the flanges 14a, 14b together. The end, side and central walls 21, 22, 23, 24, 25 may also be connected to each other in a similar manner.

The central wall 25 of the outer framework 220, which is adjacent to the flanges 14a, 14b of both air compartments 10a, 10b is therefore connected to both air compartments 10a, 10b. This can be done by placing the respective flanges 14a, 14b of the two air compartments 10a, 10b in edgewise abutment with each other, as shown in FIG. 8. This avoids any undesirable overlap of the flanges 14a, 14b, which is possible because, as explained above, the flanges 14a, 14b are not as wide along the edges of the top and bottom faces 13a, 17a; 13b, 17b which are adjacent to the side faces 11a, 15b of the two air compartments 10a, 10b. On the other hand, the security of the connection between the flanges 14a, 14b and the central wall 25 may be increased by means of an additional thin strip 26 of material, such as of polyurethane foam or fabric, which is positioned over the join between the flanges 14a, 14b and the central wall 25, as shown in FIGS. 7 and 8, and connected to both of the flanges 14a, 14b, for example by stitching or by being bonded to them with a layer of adhesive.

FIG. 9 shows a second type of air compartment 110. The air compartment 110 is again generally cuboidal in shape, with a pair of end faces 119, a pair of side faces, and two opposing major surfaces, the last of which respectively define top and bottom faces of the air compartment 110. The air compartment 110 is also made of a flexible but substantially airtight material, such as rubberized cotton. The air compartment 110 comprises an internal cavity 112, which can be inflated with air and also deflated via a tube 116, which is in communication with the internal cavity 112. The tube 116 may further comprise a substantially airtight valve. Whereas in the representative example shown in FIG. 9, the tube 116 is mounted on one of the two end faces 119 of the air compartment 110, it could equally well instead be mounted on one of the two side faces. Unlike the first type of air compartment 10 shown in FIG. 1 and described above, the second type of air compartment 110 does not have any flanges.

FIGS. 10 and 11 show a third embodiment of a mattress interior 40, which is suitable for a single bed. As before, a mattress may be made from the mattress interior 40 by fitting it with a cover, for example made of fabric, which may be permanently fixed to the mattress interior 40, for example by stitching, or which may be removable, for example if the cover comprises one or more fasteners, such as zips.

The mattress interior 40 comprises an air compartment 110 of the type shown in FIG. 9 and an outer framework which is similar to that shown in FIG. 2, but which further comprises a bottom layer 27 and a top layer 28, both of which are also made of a self-supporting but resilient and relatively soft material, such as polyurethane foam. The top layer 28 is substantially thicker than the bottom layer 27. The mattress interior 40 is assembled by placing the end and side walls 21, 22, 23, 24 of the outer framework on the bottom layer 27 and connecting each of the end and side walls 21, 22, 23, 24 to the bottom layer 27, for example using a layer of adhesive and/or by stapling them together, in order to form a five-sided cuboidal box. The end and side walls 21, 22, 23, 24 may also be connected to each other in a similar manner. The air compartment 110 is then placed in this five-sided box, and the tube 116 of the air compartment 110 is fed through the through-hole or channel 29 formed in the end wall 22, before the air compartment 110 is inflated via the tube 116. The top layer 28 is then placed on top of the end and side walls 21, 22, 23, 24, and united with them by connecting the end and side walls 21, 22, 23, 24 to the top layer 28, for example again using a layer of adhesive and/or by stapling them together, which thereby encloses the air compartment 110 within a sealed cuboidal box formed by the bottom layer 27, the top layer 28, and the end and side walls 21, 22, 23, 24.

The connection of the end and side walls 21, 22, 23, 24 of the outer framework to the bottom layer 27 and to the top layer 28 thereof, as well as possibly also to each other, may be better understood by reference to FIG. 12. FIG. 12 shows an enlargement of the area of FIG. 11 indicated by the circle labelled E in FIG. 11. As may be seen from FIG. 12, the top layer 28 is connected to side wall 24 by being bonded to it using a layer of adhesive 44. Alternatively or additionally, the top layer 28 and the side wall 24 can be connected to each other by stapling them together. The same type of connection can be made at each of the junctions of the top layer 28 with the end and side walls 21, 22, 23, 24, at each of the junctions of the bottom layer 27 with the end and side walls 21, 22, 23, 24, as well as at the junctions of the end and side walls 21, 22, 23, 24 with each other.

FIGS. 13 and 14 show a fourth embodiment of a mattress interior 240, which is suitable for a double bed. As before, a mattress may be made from the mattress interior 240 by fitting it with a cover, for example made of fabric, which may be permanently fixed to the mattress interior 240, for example by stitching, or which may be removable, for example if the cover comprises one or more fasteners, such as zips.

The mattress interior 240 comprises two air compartments 110a, 110b of the type shown in FIG. 9 and an outer framework which is similar to that shown in FIG. 6, but which also comprises a bottom layer 27 and a top layer 28, both of which are also made of a self-supporting but resilient and relatively soft material, such as polyurethane foam. The top layer 28 is substantially thicker than the bottom layer 27. The mattress interior 240 shown in FIGS. 13 and 14 is assembled by placing the end, side and central walls 21, 22, 23, 24, 25 on the bottom layer 27 and connecting each of the end, side and central walls 21, 22, 23, 24, 25 to the bottom layer 27, for example using a layer of adhesive and/or by stapling them together, in order to form a five-sided cuboidal box, which is divided into two substantially equal halves by the central wall 25. The end, side and central walls 21, 22, 23, 24, 25 may also be connected to each other in a similar manner. Each of the two air compartments 110a, 110b is then placed in a respective one of the two halves of the outer framework 220, one on each side of the central wall 25. The respective tubes 116a, 116b of the two air compartments 110a, 110b are then fed through a respective one of the two through-holes or channels 29a, 29b formed in the end wall 22, before the two air compartments 110a, 110b are inflated via the respective tubes 116a, 116b. The top layer 28 is then placed on top of the end, side and central walls 21, 22, 23, 24, 25, and united with them by connecting the end, side and central walls 21, 22, 23, 24, 25 to the top layer 28, for example by bonding them together using a layer of adhesive and/or by stapling them together, thereby enclosing each of the two air compartments 110a, 110b within a sealed cuboidal box formed by the bottom layer 27, the top layer 28 and respective ones of the end, side and central walls 21, 22, 23, 24, 25. The connection of the end, side and central walls 21, 22, 23, 24, 25 to the bottom layer 27 and to the top layer 28, as well as possibly also to each other, may be carried out as described above in relation to FIG. 12.

All of the embodiments of mattress interiors 30, 230, 40, 240 described above in relation to FIGS. 1 to 14 comprise air compartments 10, 10a, 10b, 110, 110a, 110b, each of which has only a single internal cavity 12, 12a, 12b, 112, 112a, 112b, which can be inflated and deflated via a respective tube 16, 16a, 16b, 116, 116a, 116b. However, any of the embodiments described above may be modified by replacing any one of the air compartments described above with an air compartment comprising multiple internal cavities, each of which can be inflated and deflated via a respective tube independently of each other, for example in order to provide separately adjustable levels of support for different parts of a prone human body, such as the head and shoulders, the torso and arms, and the legs.

FIG. 15 shows an embodiment of a method 50 of manufacturing a mattress. The method 50 comprises a step 51 of constructing an outer framework, such as the frameworks 20, 220 described above. The method 50 also comprises a step 52 of inflating one or more air compartments, such as the air compartments 10, 10a, 10b, 110, 110a, 110b described above. The method 50 then comprises a step 53 of assembling the mattress from the outer framework and the one or more air compartments in order to make a mattress interior, such as the mattress interiors 30, 230, 40, 240 described above, and fitting the mattress interior with a cover such as that described above, in order to make the mattress, before a step 54 of deflating the one or more air compartments again, and a step 55 of packing the mattress into a smaller volume for dispatch from the factory where the mattress has been made.

The steps 51 to 55 of the method 50 may be carried out in any order, provided that the step 52 of inflating the one or more air compartments precedes the step 53 of assembling the mattress, and the step 54 of deflating the one or more air compartments comes after the assembly step 53 and before the packing step 55. In other words, the step 51 of constructing the outer framework and the step 52 of inflating the one or more air compartments may be carried out in any order, for example by inflating the one or more air compartments first and placing the inflated air compartments into a pre-constructed outer framework, or by placing one or more deflated air compartments into a pre-constructed outer framework and then inflating them, or by constructing the outer framework around one or more pre-inflated air compartments. The important points, however, are firstly that when the assembly step 53 is carried out, the one or more air compartments are inflated, thereby allowing the mattress to be assembled in a shape and configuration which mimic those of its intended final state when in use, and secondly that when the packing step 55 is carried out, the one or more air compartments have been deflated again, thereby allowing the assembled mattress to be packed into a smaller volume, without any risk of the one or more air compartments being caused to pop, and thereby being damaged, by being compressed during packing.

The steps 52 of inflating the one or more air compartments and 54 of deflating the one or more air compartments again may both be carried out for example by attaching the tubes 16, 16a, 16b, 116, 116a, 116b of the one or more air compartments to a vacuum pump. The packing step 55 may be carried out for example by folding the mattress using a folding machine and/or by roll packing the mattress using a roll-packing machine of the type used to roll pack other items such as duvets, before wrapping the folded and/or roll-packed mattress for example in a protective layer of a plastics material.

1. A mattress interior comprising:
an outer framework made of a self-supporting, resilient material; and
one or more air compartments, each made of a flexible, substantially airtight material;
wherein the one or more air compartments can be inflated and deflated, and the one or more air compartments are secured within the outer framework by at least one of (a) being connected to the outer framework, and (b) elements of the outer framework being connected to each other to contain the one or more air compartments therein, wherein each of the one or more air compartments is generally cuboidal in shape, with a pair of end faces, a pair of side faces, and two opposing major surfaces defining top and bottom faces of each air compartment, each of the one or more air compartments comprising a flange extending around an edge of each of the top and bottom faces thereof.

2. (canceled)

3. A mattress interior according to claim 1, wherein a width of each flange lies in a range of from 40 to 150 mm.

4. A mattress interior according to claim 3, wherein the outer framework comprises two end walls and two side walls, each of which is generally cuboidal in shape, and all of which are of a similar height to each other, which height is substantially equal to a separation between the flanges around the edges of each of the top and bottom faces of the one or more air compartments, the end and side walls being connected to the flanges.

5. A mattress interior according to claim 4, comprising two such air compartments and wherein the outer framework further comprises a central wall which is generally cuboidal in shape and of a similar height to the end and side walls the central wall extending between the middles of each of the two end walls, dividing a space between the side walls into two substantially equal halves, each of which contains one of the two air compartments, the central wall being connected to the flanges of the two air compartments.

6. A mattress interior according to claim 5, wherein a width of the flanges of the two air compartments adjacent to the central wall is less than the width of the flanges adjacent to the end and side wall, and the flanges of one of the two air compartments adjacent to the central wall are in edgewise abutment with the flanges of the other of the two air compartments adjacent to the central wall.

7. A mattress interior according to claim 6, further comprising a strip of material, positioned over a join between the flanges and the central wall and connected to the flange of each of the two air compartments.

8. A mattress interior according to claim 1, wherein the outer framework comprises:
two end walls and two side walls, each of which is generally cuboidal in shape, and all of which are of a similar height to each other;
a bottom layer; and
a top layer;
wherein the end walls and the side walls are positioned on and connected to the bottom layer, and the top layer is positioned on and connected to the end walls and the side walls.

9. A mattress interior according to claim 8, wherein the top layer is substantially thicker than the bottom layer.

10. A mattress interior according to claim 8, comprising two such air compartments and wherein the outer framework further comprises a central wall which is generally cuboidal in shape and of a similar height to the end and side walls, the central wall extending between the middles of each of the two end walls, dividing a space between the side walls into two substantially equal halves, each of which contains one of the two air compartments, the central wall being connected to the bottom layer and the top layer.

11. A mattress interior according to claim 1, wherein at least one of the one or more air compartments comprises a plurality of internal cavities, each of which can be inflated and deflated independently of each other.

12. A mattress interior according to claim 1, wherein the self-supporting, resilient material is polyurethane foam.

13. A mattress interior according to claim 1, wherein the flexible, substantially airtight material is rubberized cotton.

14. A mattress comprising:
a mattress interior according to claim 1; and
a cover fitted to an outside of the mattress interior.

15. A method of manufacturing a mattress, the method comprising:
constructing an outer framework made of a self-supporting, resilient material;
inflating one or more air compartments each made of a flexible, substantially airtight material;
assembling the mattress by securing the one or more air compartments within the outer framework to make a mattress interior and fitting the mattress interior with a cover;
deflating the one or more air compartments; and
packing the mattress into a smaller volume.

16. A method of manufacturing a mattress according to claim 15, wherein the one or more air compartments are secured within the outer framework by connecting the one or more air compartments to the outer framework.

17. A method of manufacturing a mattress according to claim 15, wherein the one or more air compartments are secured within the outer framework by connecting elements of the outer framework to each other to contain the one or more air compartments therein.

18. A method of manufacturing a mattress according to claim 15, wherein the mattress is packed into a smaller volume using a roll-packing machine.
